(19) United States
(12) Patent Application Publication
(10) Pub. No.: US 2026/0276116 A1
(43) Pub. Date: Sep. 17, 2026

(54) CONTAINMENT CONNECTOR

(71) Applicant: HAM-LET (ISRAEL - CANADA ) LTD, Nof Hagalil (IL)

(72) Inventors: Boris MARGOL, Nof Hagali (IL); Sergiy SERYOGIN, Nof Hagali (IL)

(73) Assignee: HAM-LET (ISRAEL - CANADA ) LTD, Nof Hagalil (IL)

(21) Appl. No.: 19/162,461

(22) PCT Filed: Mar. 5, 2024
(86) PCT No.: PCT/IL2024/050240

§ 371 Date: Sep. 5, 2025

(30) Foreign Application Priority Data
Mar. 5, 2023 (IL) 301148

(51) Int. Cl. F16L 19/02; F16L 19/025

(52) U.S. Cl. CPC F16L 19/0212; F16L 19/025

(57) ABSTRACT

A containment connector comprising: a. at least one female part, each having a coupling end for hermetically coupling the respective female part to one of the at least one first pipe, and a female mating end having an internal thread for mating with one of at least one male part; b. each of said at least one male part having a coupling end, and a male mating end having an external thread for mating with one of said at least one female part; c. means for sealing the connector by forcing male mating end, and/or a circular groove in each male mating end and an opposite female mating end; d. a space between an interior of the connector and at least a portion of an external surface of the joint; and eat least one port allowing connecting the space with an exterior of the connector.

### BACKGROUND OF THE INVENTION

Semi-conductor manufacturing systems, for example only, include pipes where toxic gases flow, and joints that connect such pipes. Even though pipe joints are designed to avoid any gas leakage, some failures that lead to gas leaks do occur. Thus, there is a need to further secure the joints by additional means to keep teams and equipment from exposure to toxic or hazardous gases.

### BRIEF SUMMARY OF THE INVENTION

According to one aspect, a containment connector for containing a joint joining at least one first fluid pipe and at least one second fluid pipe is provided. The connector comprises at least one female part, and at least one male part. The female parts each have a coupling end for hermetic coupling to the first pipe, and a female mating end with an internal thread for mating with at least one male part. The male parts each have a coupling end for hermetic coupling to the second pipe, and a male mating end with an external thread for mating with at least one female part. A circular groove in the female mating end receives an O-ring for sealing the connector by forcing the O-ring against a flat smooth surface on an opposite male mating end. Alternatively, a circular groove in the male mating end receives an O-ring for sealing the connector by forcing the O-ring against a flat smooth surface on an opposite female mating end. Also, there is a space between an interior of the connector and a portion of an external surface of the joint. The space receives a fluid leaking out of the joint. The connector further includes at least one port connecting the space with an exterior of the connector.

According to one aspect, a containment connector is provided for containing a joint joining at least one first fluid pipe and at least one second fluid pipe, the connector comprising:
a. at least one female part, each having a coupling end for hermetically coupling the respective female part to one of the at least one first pipe, and a female mating end having an internal thread for mating with one of at least one male part;
b. each of said at least one male part having a coupling end for hermetically coupling the respective male part to one of the at least one second pipe, and a male mating end having an external thread for mating with one of said at least one female part;
c. a circular groove in each female mating end for receiving an O-ring for sealing the connector by forcing the O-ring against a flat smooth surface on an opposite male mating end, and/or a circular groove in each male mating end for receiving an O-ring for sealing the connector by forcing the O-ring against a flat smooth surface on an opposite female mating end;
d. a space between an interior of the connector and at least a portion of an external surface of the joint, the space being configured for receiving a fluid leaking out of the joint; and
e. at least one port allowing connecting the space with an exterior of the connector.

In some embodiments the coupling ends have threads for respective nuts pressing sealing elements upon the respective coupled pipes.

In some embodiments the sealing elements are conic ferrules, O-rings, or a combination thereof.

In some embodiments said space has of a volume of at least 1 cm³.

In some embodiments a port is installed in each of said at least one male part and/or each of at least one female part allows connecting the space with an exterior of the connector.

In some embodiments said port is connected to at least one of a pressure gauge, a leak detector, a closed reservoir configured for safe receiving of a leaked fluid, and a stopper.

In some embodiments each of the at least one female part and each of the at least one male part has the mating end wider than the coupling end.

In some embodiments each of the at least one female part and each of the at least one male part has a rectangular part in between the mating end and the coupling end.

In some embodiments each of the at least one female part and each of the at least one male part has knurling on the mating end and/or on the coupling end.

In some embodiments the pipes and the joint are configured to withstand a predetermined maximal fluid pressure, and the connector is configured to withstand a pressure larger than said maximal fluid pressure by at least 30%.

In some embodiments each of the at least one male and at least one female parts of the connector include metallic or polymer materials.

According to another aspect, a method is provided for installing a containment connector over a joint joining a first fluid pipe and a second fluid pipe, the method comprising:
a. inserting an O-ring into a circular groove in a mating end of a male part and/or of a female part of the connector, wherein said O-ring allows sealing the connector by coupling a mating end to a flat smooth surface on an opposite mating end of a respective female part or a male part of the connector;
b. inserting an end of the first pipe through a first ordered series including a nut, at least one sealing element, and a coupling end of a female part of the connector having a thread for receiving the nut, or through said first ordered series in reverse;
c. inserting an end of the second pipe through a second ordered series including a nut, at least one sealing element and a coupling end of a male part of the connector having a thread for receiving the nut or through said second ordered series in reverse;
d. screwing said male part into said female part, wherein the male part having an external thread and the female part having a corresponding internal thread, and said O-ring being pressed on said flat smooth surface, wherein a space is formed between an interior of the connector and at least a portion of an external surface of the joint allowing receiving a fluid leaking out of the joint;
e. screwing nuts over the respective sealing elements and over threads of the coupling ends of the connector parts for hermetic coupling the female or male part to the respective pipes; and
f. installing at least one receiving element on at least one port allowing connecting the space with an exterior of the connector.

In some embodiments the method includes a step of joining the first fluid pipe and the second fluid pipe, wherein the step of joining the pipes is executed before or after the step of inserting an end of the first pipe through a first ordered series and the step of inserting an end of the second pipe through a second ordered series.

In some embodiments the method includes inserting an end of the first pipe through an ordered series including a nut, at least one sealing element, and a coupling end of a female part of the connector having a thread for receiving the nut.

In some embodiments the method includes inserting an end of the first pipe through an ordered series including a female part of the connector having a thread for receiving, at least one sealing element, and a nut.

In some embodiments the method includes inserting an end of the second pipe through an ordered series including a nut, at least one sealing element and a coupling end of a male part of the connector having a thread for receiving the nut.

In some embodiments the method includes inserting an end of the second pipe through an ordered series including a coupling end of a male part of the connector having a thread for receiving a nut, at least one sealing element and a nut.

In some embodiments the method includes inserting an O-ring into a circular groove in a mating end of a male part of the connector, wherein said O-ring being configured for sealing the connector by coupling to a flat smooth surface on an opposite mating end of a female part of the connector.

In some embodiments said at least one port is installed in said male part and/or in said female part.

In some embodiments the method includes connecting said port to at least one of a pressure gauge, a leak detector, a closed reservoir configured for safe receiving of a leaked fluid, or a stopper.

Some embodiments further comprise subsequent to steps a)-e) sucking via the at least one port air out of the connector and subsequently leaving the connecter under sub-pressure relative to atmospheric pressure outside the connector.

According to another aspect, a containment connector is provided for containing a joint joining at least one first fluid pipe and at least one second fluid pipe, the connector comprising:
a. at least one female part, each having a coupling end for hermetically coupling the respective female part to one of the at least one first pipe, and a female mating end for mating with one of at least one male part;
b. each of said at least one male part having a coupling end for hermetically coupling the respective male part to one of the at least one second pipe, and a male mating end for mating with one of said at least one female part;
c. means for urging each female mating end against an opposite male mating end, in a direction essentially parallel to the length of a pipe coupled to the male part of the male mating end or the female part of the female mating end, and for sealing a gap between female mating end against an opposite male mating end;
d. a space between an interior of the connector and at least a portion of an external surface of the joint, the space being configured for receiving a fluid leaking out of the joint; and
e. at least one port allowing connecting the space with an exterior of the connector.

In some embodiments means for urging each female mating end against an opposite male mating end are selected from a group consisting of: threads, clamps, clasps, and a combination thereof.

In some embodiments means for sealing a gap between female mating end against an opposite male mating end are selected from a group consisting of: O-rings, gaskets and a combination thereof.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1A is a perspective view of a containment connector for containing a joint joining two pipes according to a preferred embodiment.

FIG. 1B is a cross-section of the connector shown in FIG. 1A.

FIG. 2A is a schematic perspective view of a female part of the connector.

FIG. 2B is a cross section of the female part shown in FIG. 2A.

FIG. 2C shows a segment of a thread on a coupling end of the female or male parts.

FIG. 2D shows a segment of an internal thread of a mating end of the female part shown in FIG. 2A.

FIG. 3A is a perspective view of a male part of the connector shown in FIG. 1A, exhibiting a port.

FIG. 3B is a cross section of the male part shown in FIG. 3A along a plane which bisects the port.

FIG. 3C is a cross section of the male part shown in FIG. 3D along a plane perpendicular to the bisection plane of FIG. 3B.

FIG. 3D shows a segment of an external thread of a mating end of the male part shown in FIG. 3A.

FIG. 4A is a perspective enlarged view of the coupling end of the male part shown in FIG. 3A, or of the female part shown in FIG. 2A.

FIG. 4B is a cross section view of the coupling end coupled to a pipe by a hexagonal nut, a conic ferrule and an O-ring.

FIG. 4C is an expanded view of the coupling end, showing the conic ferrule, an O-ring holder, and the hexagonal nut.

FIG. 5 is a flowchart of a method for installing a containment connector over a joint joining two pipes.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems is necessary to implement the invention as claimed in any particular claim of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining an embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

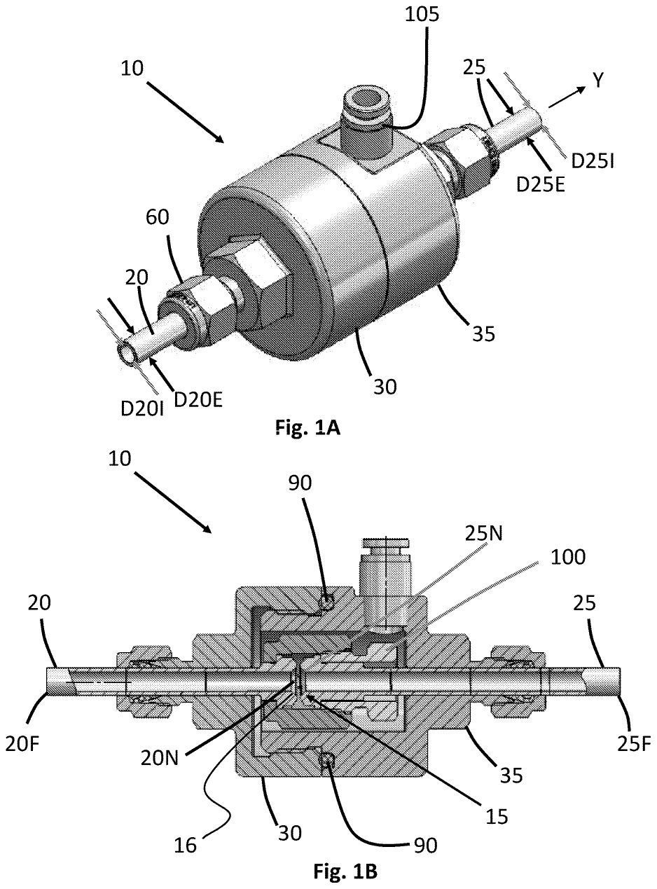

Semi-conductor manufacturing systems, for example only, include pipes where toxic gases flow, and joints that connect such pipes. Even though pipe joints are designed to prevent any gas leakage, some failures that lead to gas leaks do occur. Thus, there is a need to secure the joints by additional means to keep teams and equipment protected from toxic or hazardous gases. Such means is a containment connector 10, shown in the perspective view of FIG. 1A and in the corresponding cross-section drawing of FIG. 1B. The connector 10 contains a joint 15 joining two pipes 20 and 25 and thus enables control of the leak from the joint 15, if it occurs. The connector 10 comprises a female part 30 and a male part 35 which mate with each other to close the vicinity of the joint.

One of the advantages of this kind of containment connector is easy adaptation of the connector's structure for more complex flow systems. For example, some embodiments comprise more than one female part and/or more than one male part, to allow connecting more than two pipes to each other and containing their joints. One or more of such parts e.g., two female parts, may have a structure exactly like, or similar to, the structures described below. Other corresponding parts, e.g., a single male part, may be appropriately adapted in their structure to allow for such connecting, as will be clear to skilled in the art, but will generally be faithful to the structures described below.

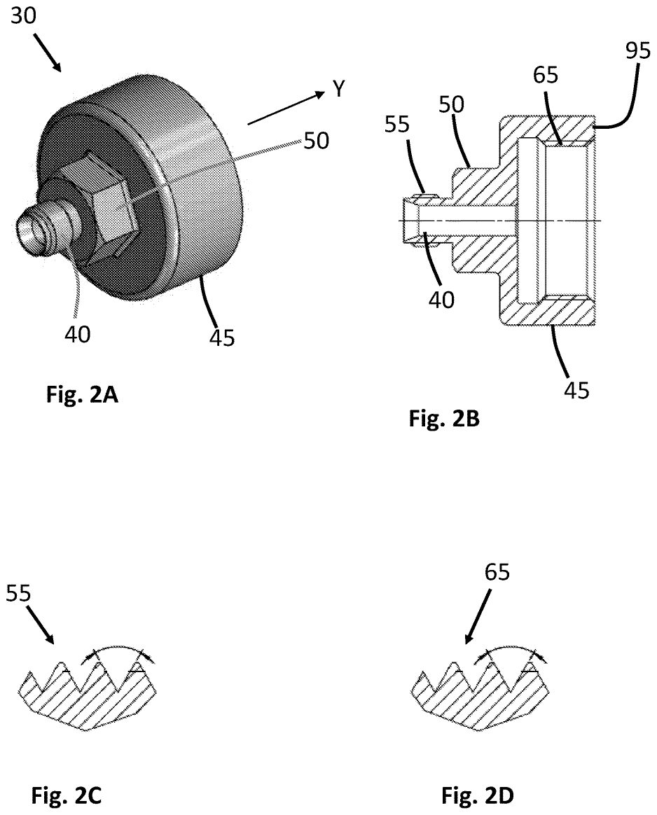

FIG. 2A is a perspective schematic view of the female part 30, and FIG. 2B is a cross section thereof. The female part 30 has a relatively narrow coupling end 40 for hermetically coupling the female part to the pipe 20, a relatively wide mating end 45 for mating with the male part 35, and a hexagonal part 50 in between. A thread 55 in the coupling end 40, shown in FIGS. 2B and 2C [not shown in FIG. 2A], enables receiving a nut 60 shown in FIG. 1A for coupling the female part 30 to the pipe 20, as further detailed below.

The mating end 45 has an internal thread 65, as shown in FIGS. 2B and 2D, for mating with a corresponding external thread of the male part 35.

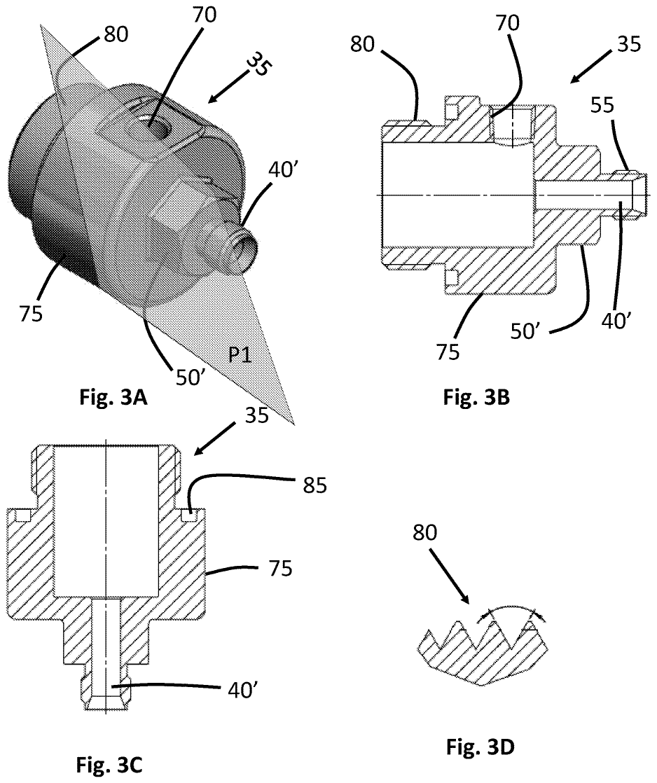

Referring now to the male part 35, it is illustrated in FIGS. 3A-3D. FIG. 3B is a cross section of the male part 35 along a plane P1 which bisects port 70. FIG. 3C is a cross section of the male part 35 along a plane perpendicular to the plane of FIG. 3B. The male part 35 includes a relatively narrow coupling end 40′ for hermetically coupling the male part to the pipe 25, a relatively wide mating end 75, from which an external mating thread 80 protrudes, and a rectangular e.g., hexagonal part 50′, between the coupling end 40′ and the mating end 75. The external mating thread 80 is engaged by rotation with the internal mating thread 65 of the female part 30 around axis Y. The hexagonal parts 50 and 50′ in the female and male parts, respectively, facilitate mutual rotation using a corresponding hexagonal key, a wrench or other suitable tool (not shown).

In alternative embodiments the coupling ends and/or the mating ends and/or nuts comprise knurling, which may facilitate tightening by hand of the parts. With knurling on the mating ends there may be no hexagonal part 45 or other rectangular part for tightening with a tool. Other means can be used to facilitate or enable the tightening, depending upon the amount of required or optimal force.

For further hermetic sealing, a circular groove 85 in the male mating end 75 receives an O-ring 90, shown in FIG. 1B. Thus, the rotation of the female relative to the male parts in a closing direction forces the O-ring 90 against a flat smooth surface 95 on an opposite female mating end 45, shown in FIG. 2B.

Referring to FIG. 1B, there is a space 100 between an interior of the connector 10 and a portion of an external surface 16 of the joint 15. In some embodiments, the space 100 has a volume of at least 5 cm³, at least 2 cm³ or at least 1 cm³. The space 100 can receive a fluid leaking out of the joint 15, if such a leak occurs. The port 70 allows to safely connect the space 100 with an exterior of the connector 10 in order to safely remove leaked fluid. The port 70 may be connected for example to a pressure gauge, a leak detector, a closed reservoir configured for safe receiving of a leaked fluid, or to a stopper 105, or a combination thereof.

Referring back to FIG. 1A, the outer diameters D20E and D25E of the respective pipes 20 and 25 are substantially the same. Also, the inner diameters D20I and D25I of the respective pipes 20 and 25 are substantially the same. Alternatively, in some embodiments the two pipes 20 and 25 have a different inner diameter, or different outer diameter, or both.

For later use below, proximal ends 20N and 25N of respective pipes 20 and 25, which are coupled by joint 15, as well as distal ends 20F and 25F, are designated on FIG. 1B.

Usually, the pipes 20 and 25 and the joint 15 are designed and made for withstanding a predetermined maximal fluid pressure. Accordingly, the connector is configured to withstand a pressure larger than the predetermined maximal fluid pressure by most preferably at least 60%, less preferably by at least 30%, or least preferably by at least 20%.

The male and female parts of the connector 10 may include metallic or polymer materials or combinations thereof. Preferably, these materials include elastomers, The materials are preferably inert to the fluids that might leak from the joint.

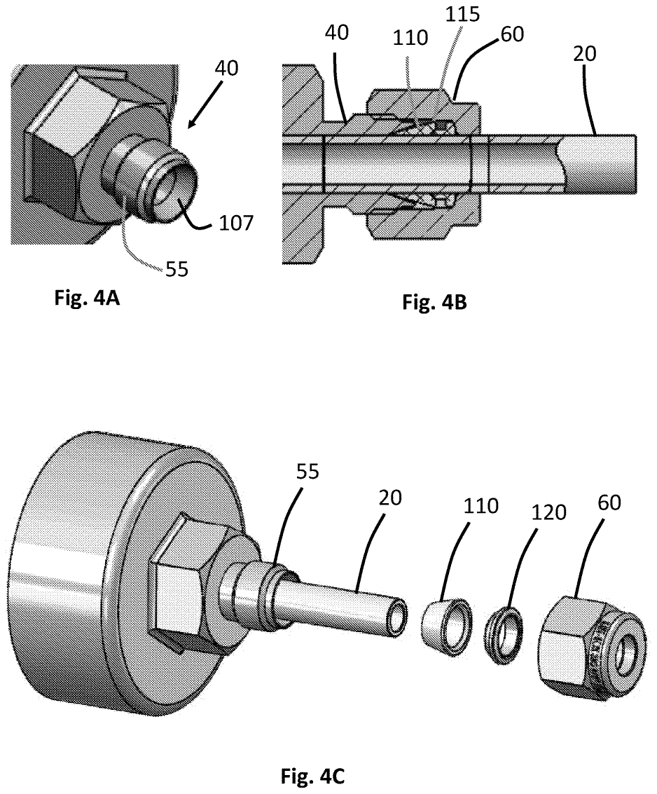

For further discussion of the hermetic sealing of the coupling ends 40 and 40′ to the respective pipes 20 and 25, reference is made to FIGS. 4A, 4B, and 4C which respectively present a perspective enlarged view, a cross section view and an expanded view of the coupling end 40. The coupling end 40 includes a conic termination 107 for receiving a compatible conic ferrule 110. A conic ferrule 110, and an O-ring 115 held by O-ring holder 120 are inserted into the coupling end 40, and a hexagonal nut 60 is screwed over thread 55 to ensure hermetic sealing and affixation of the connector to the pipes.

Alternative arrangements of sealing means incorporated in the containment connector can be used to hermetically seal and affix the connector as will occur to the skilled in the art.

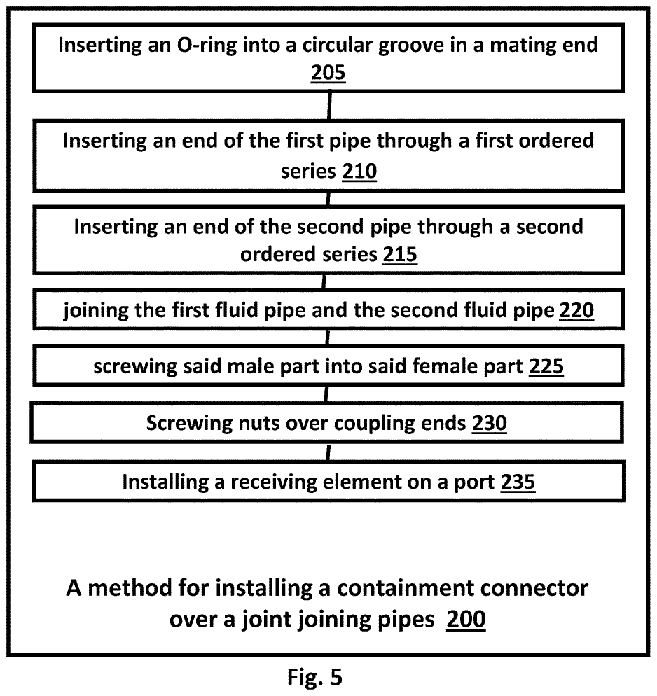

FIG. 5 is a flowchart of a method 200 for installing a containment connector 10 over a joint 15 joining two pipes 20 and 25. The method comprises a step 205 of inserting an O-ring 90 into a circular groove in a mating end 75 of a male part 35, a step 210 of inserting an end of the pipe 20 through a series of elements, a step 215 of inserting an end of the pipe 25 through a series of elements, a step 225 of screwing the male part 35 into the female part 30, a step 230 of screwing nuts 60 over sealing elements 110 and 115 and over threads 55 and 55′ of the respective coupling ends 40 and 40′ of the female and male parts for hermetic coupling to the respective pipes 20 and 25, and the step 235 of installing a receiving element 105 on an exit of a port 70 connecting a space 100 between the connector 10 and the joint 15 with an exterior of the connector 10.

The O-ring 90 seals the connector 10 by forcing it to a flat smooth surface 95 on an opposite mating end 45 of the female part 35. An end of the pipe 20 is inserted through a first ordered series which includes a hexagonal nut 60, a conic ferrule 110, an O-ring holder 120, and a coupling end 40 of a female part 30 which has a thread 55 for receiving the nut 60, or through the first ordered series in reverse. An end of the pipe 25 is inserted through a second ordered series, substantially the same as the first ordered series or through the second ordered series in reverse.

A mating end 75 of the male part 35 has an external thread 80, while a mating end 45 of the female part 30 has a corresponding internal thread 65. The space 100 is formed between an interior of the connector 10 and an external surface of the joint 15, and is ready to receive a fluid leaking out of the joint 15, The nuts 60 are screwed over the respective conic ferrules 110 and O-ring holders 120, and over respective threads 55 of the coupling ends 40 and 40′ of the connector male and female parts for hermetic coupling to the respective pipes 20 and 25.

The method may include a step 220 of joining the fluid pipes 20 and 25. Usually, the step 220 is executed after the step 210 of inserting an end of the pipe 20 through a first ordered series and the step 215 of inserting an end of the pipe 25 through a second ordered series. In such a case, the proximal ends 20N and 25N of the respective pipes 20 and 25, which the joint 15 couples to each other, are still available for the respective steps 210 and 215 of inserting. The order of inserting is a nut 60, a ferrule 110 an O-ring holder 120, and a coupling end 40 or 40′ which has a thread 55 for receiving the nut 60.

In case that there is an access to the distal ends 20F and 25F of the respective pipes 20 and 25, the step 220 of joining the pipes may be executed before the steps 210 and 215, and the order inserting of the first and second ordered series is reversed.

In some embodiments, after assembling the containment connector, but before flowing fluid via the pipes, a sub-pressure is created within the connector relative to the environment outside the connector, for example by operationally and fluidically connecting a vacuum pump to the port, opening the port and sucking air out of the connector, and closing the port while the vacuum pump is sucking. This sub-pressure can help prevent build-up of pressure within the connector and allow for time to safely fix the contained leak out of the pipes.

The following are some aspects and embodiments that contribute to the definition of the invention contemplated herein:
AA. A containment connector for containing a joint joining at least one first fluid pipe and at least one second fluid pipe, the connector comprising:
   a. at least one female part, each having a coupling end for hermetically coupling the respective female part to one of the at least one first pipe, and a female mating end having an internal thread for mating with one of at least one male part;
   b. each of said at least one male part having a coupling end for hermetically coupling the respective male part to one of the at least one second pipe, and a male mating end having an external thread for mating with one of said at least one female part;
   c. a circular groove in each female mating end for receiving an O-ring for sealing the connector by forcing the O-ring against a flat smooth surface on an opposite male mating end, and/or a circular groove in each male mating end for receiving an O-ring for sealing the connector by forcing the O-ring against a flat smooth surface on an opposite female mating end;
   d. a space between an interior of the connector and at least a portion of an external surface of the joint, the space being configured for receiving a fluid leaking out of the joint; and
   e. at least one port allowing connecting the space with an exterior of the connector.
AB. The connector of AA wherein the coupling ends have threads for respective nuts pressing sealing elements upon the respective coupled pipes.
AC. The connector of claim AB wherein the sealing elements are conic ferrules, O-rings, or a combination thereof.
AD. The connector of any one of AA-AC wherein said space has of a volume of at least 1 cm³. Preferably, the space has a significantly larger volume, for example, at least 10 cm³.
AE. The connector of any one of AA-AD wherein a port installed in each of said at least one male part and/or each of at least one female part allows connecting the space with an exterior of the connector.
AF. The connector of any one of AA-AE wherein said port is connected to at least one of a pressure gauge, a leak detector, a closed reservoir configured for safe receiving of a leaked fluid, and a stopper.
AG. The connector of any one of AA-AF wherein each of the at least one female part and each of the at least one male part has the mating end wider than the coupling end.
AH. The connector of any one of AA-AG wherein each of the at least one female part and each of the at least one male part has a rectangular part in between the mating end and the coupling end.
AI. The connector of any one of AA-AG wherein each of the at least one female part and each of the at least one male part has knurling on the mating end and/or on the coupling end.
AJ. The connector of any one of AA-AI wherein the pipes and the joint are configured to withstand a predetermined maximal fluid pressure, and the connector is configured to withstand a pressure larger than said maximal fluid pressure by at least 30%.
AK. The connector of any one of AA-AJ wherein each of the at least one male and at least one female parts of the connector include metallic or polymer materials.
BA. A method for installing a containment connector over a joint joining a first fluid pipe and a second fluid pipe, the method comprising:
   a. inserting an O-ring into a circular groove in a mating end of a male part and/or of a female part of the connector, wherein said O-ring allows sealing the connector by coupling a mating end to a flat smooth surface on an opposite mating end of a respective female part or a male part of the connector;
   b. inserting an end of the first pipe through a first ordered series including a nut, at least one sealing element, and a coupling end of a female part of the connector having a thread for receiving the nut, or through said first ordered series in reverse;
   c. inserting an end of the second pipe through a second ordered series including a nut, at least one sealing element and a coupling end of a male part of the connector having a thread for receiving the nut or through said second ordered series in reverse;
   d. screwing said male part into said female part, wherein the male part having an external thread and the female part having a corresponding internal thread, and said O-ring being pressed on said flat smooth surface, wherein a space is formed between an interior of the connector and at least a portion of an external surface of the joint allowing receiving a fluid leaking out of the joint;
   e. screwing nuts over the respective sealing elements and over threads of the coupling ends of the connector parts for hermetic coupling the female or male part to the respective pipes; and
   f. installing at least one receiving element on at least one port allowing connecting the space with an exterior of the connector.
BB. The method of BA wherein the method includes a step of joining the first fluid pipe and the second fluid pipe, wherein the step of joining the pipes is executed before or after the step of inserting an end of the first pipe through a first ordered series and the step of inserting an end of the second pipe through a second ordered series.
BC. The method of BA or BB wherein the method includes inserting an end of the first pipe through an ordered series including a nut, at least one sealing element, and a coupling end of a female part of the connector having a thread for receiving the nut.
BD. The method of BA or BB wherein the method includes inserting an end of the first pipe through an ordered series including a female part of the connector having a thread for receiving, at least one sealing element, and a nut.
BE. The method of any one of BA-BD wherein the method includes inserting an end of the second pipe through an ordered series including a nut, at least one sealing element and a coupling end of a male part of the connector having a thread for receiving the nut.
BF. The method of any one of BA-BD wherein the method includes inserting an end of the second pipe through an ordered series including a coupling end of a male part of the connector having a thread for receiving a nut, at least one sealing element and a nut.
BG. The method of any one of BA-BF wherein the method includes inserting an O-ring into a circular groove in a mating end of a male part of the connector, wherein said O-ring being configured for sealing the connector by coupling to a flat smooth surface on an opposite mating end of a female part of the connector.
BH. The method of any one of BA-BG wherein said at least one port is installed in said male part and/or in said female part.
BI. The method of any one of BA-BH wherein the method includes connecting said port to at least one of a pressure gauge, a leak detector, a closed reservoir configured for safe receiving of a leaked fluid, or a stopper.
BJ. The method of any one of BA-BI further comprising subsequent to steps a)-e) sucking via the at least one port air out of the connector and subsequently leaving the connecter under sub-pressure relative to atmospheric pressure outside the connector.
CA. A containment connector for containing a joint joining at least one first fluid pipe and at least one second fluid pipe, the connector comprising:
   a. at least one female part, each having a coupling end for hermetically coupling the respective female part to one of the at least one first pipe, and a female mating end for mating with one of at least one male part;
   b. each of said at least one male part having a coupling end for hermetically coupling the respective male part to one of the at least one second pipe, and a male mating end for mating with one of said at least one female part;
   c. means for urging each female mating end against an opposite male mating end, in a direction essentially parallel to the length of a pipe coupled to the male part of the male mating end or the female part of the female mating end, and for sealing a gap between female mating end against an opposite male mating end;
   d. a space between an interior of the connector and at least a portion of an external surface of the joint, the space being configured for receiving a fluid leaking out of the joint; and
   e. at least one port allowing connecting the space with an exterior of the connector.
CB. The containment connector of CA, wherein means for urging each female mating end against an opposite male mating end are selected from a group consisting of: threads, clamps, clasps, and a combination thereof.
CC. The containment connector of CA or CB, wherein for sealing a gap between female mating end against an opposite male mating end are selected from a group consisting of: O-rings, gaskets and a combination thereof.
CD. The containment connector of any one of CA to CC, further comprising any of the features defined in AD-AK.

1-24. (canceled)

25. A containment connector for containing a joint joining at least one first fluid pipe and at least one second fluid pipe, the connector comprising:
a. at least one female part, each having a coupling end for hermetically coupling the respective female part to one of the at least one first pipe, and a female mating end having an internal thread for mating with one of at least one male part;
b. each of said at least one male part having a coupling end for hermetically coupling the respective male part to one of the at least one second pipe, and a male mating end having an external thread for mating with one of said at least one female part;
c. at least one of (i) a circular groove in each female mating end for receiving an O-ring for sealing the connector by forcing the O-ring against a flat smooth surface on an opposite male mating end, and (ii) a circular groove in each male mating end for receiving an O-ring for sealing the connector by forcing the O-ring against a flat smooth surface on an opposite female mating end;
d. a space between an interior of the connector and at least a portion of an external surface of the joint, the space being isolated from interior flow passage of the pipes and configured for receiving a fluid leaking out of the joint; and
e. at least one port allowing a connection of the space with an exterior of the connector.

26. The connector of claim 25, wherein each of the coupling ends has threads configured to receive a respective threaded nut, the nut configured to axially compress at least one sealing element against a corresponding coupled pipe to form a fluid-tight seal.

27. The connector of claim 26, wherein the sealing elements comprise frusto-conical ferrules, O-rings, or a combination thereof, wherein the sealing elements, when used together, provide a dual sealing functionality.

28. The connector of claim 25, wherein said space has a volume of at least 1 cm³.

29. The connector of claim 25, wherein a port is installed in at least one of (i) a male part and (ii) a female part to allow connecting the space with the exterior of the connector.

30. The connector of claim 25, wherein said port is connected to at least one of a pressure gauge, a leak detector, a closed reservoir configured for safe receiving of a leaked fluid, and a stopper, such that leakage from the joint is monitorable or contained without release to the atmosphere.

31. The connector of claim 30, wherein the closed reservoir is configured to contain leaked fluid at a pressure equal to or greater than an operating pressure of the pipes.

32. The connector of claim 25, wherein each of the at least one female part and each of the at least one male part has the mating end wider than the coupling end, the widening defining part of the space for receiving leaked fluid.

33. The connector of claim 25, wherein each of the at least one female part and each of the at least one male part has a hexagonal part in between the mating end and the coupling end.

34. The connector of claim 25, wherein each of the at least one female part and each of the at least one male part has knurling on at least one of the mating end and the coupling end.

35. The connector of claim 34, wherein each of the at least one female part and each of the at least one male part has knurling on both the mating end and the coupling end.

36. The connector of claim 25, wherein the pipes and the joint are configured to withstand a predetermined maximal fluid pressure, and the connector is configured to withstand a pressure larger than said maximal fluid pressure by at least 30%.

37. The connector of claim 25, wherein each of the at least one male part and at least one female part of the connector include metallic or polymer materials.

38. The connector of claim 13, wherein each of the at least one male part and at least one female part of the connector consists of a polymer material, the polymer being elastic and configured to provide a lasting, flexible and tight seal when the mating ends are fastened together.

39. A containment connector for containing a joint joining at least one first fluid pipe and at least one second fluid pipe, the connector comprising:
a. at least one female part, each having a coupling end for hermetically coupling the respective female part to one of the at least one first pipe, and a female mating end for mating with one of at least one male part;
b. each of said at least one male part having a coupling end for hermetically coupling the respective male part to one of the at least one second pipe, and a male mating end for mating with one of said at least one female part;
c. means for urging each female mating end against an opposite male mating end, in a direction essentially parallel to a length of a pipe coupled to the male part of the male mating end or the female part of the female mating end, and for sealing a gap between female mating end against an opposite male mating end;
d. a space between an interior of the connector and at least a portion of an external surface of the joint, the space being isolated from an interior flow passage of the pipes and configured for receiving a fluid leaking out of the joint; and
e. at least one port allowing a connection of the space with an exterior of the connector.

40. The containment connector of claim 39, wherein means for urging each female mating end against an opposite male mating end are selected from a group consisting of:
threads, clamps, clasps, and a combination thereof.

41. The containment connector of claim 39, wherein means for sealing a gap between female mating end against an opposite male mating end are selected from a group consisting of: O-rings, gaskets and a combination thereof, the sealing means being axially compressed between the mating ends so as to provide a hermetic seal and to direct any leakage from the joint to the space.
